(19) United States
(12) Patent Application Publication
(10) Pub. No.: US 2009/0056566 A1
(43) Pub. Date: Mar. 5, 2009

(54) Tape Processing Apparatus and Method of Tape Processing

(75) Inventors: Sejii Tanaka, Nagano-ken (JP); Makoto Takada, Nagano-ken (JP); Takayuki Uehara, Tokyo (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Shinjuku-ku, Tokyo (JP)

(21) Appl. No.: 11/910,891

(22) PCT Filed: Apr. 4, 2006
(86) PCT No.: PCT/JP2006/307519

§ 371 Date: Oct. 5, 2007

(30) Foreign Application Priority Data
Apr. 8, 2005 (JP) 2005-112290

(51) Int. Cl. B31F 1/07; B41J 3/32

(52) U.S. Cl. 101/32; 400/109.1

(57) ABSTRACT

A tape processing apparatus has: mode selecting device for selecting among a print processing, a Braille-emboss processing, and a complex processing of the ink-character printing and the Braille embossing; tape-type detecting device for detecting the mounted tape type; and informing device for informing the discrepancy in a tape type, as a result of comparing a tape type which conforms to the mode selected by the mode selecting device with a tape type detected by the tape type detecting device.

### TECHNICAL FIELD

This invention relates to a tape processing apparatus in which ink-character printing and Braille embossing are performed on a processing tape, and to a tape processing method of the tape processing apparatus, as well as to a program.

### BACKGROUND ART

Conventionally, there is known a Braille label having disposed on the same tape a Braille that can be recognized by a visually-impaired person and ink characters (i.e., characters printed with ink; this term is used in this specification as compared with Braille) that can be recognized by a sighted person so that the Braille label can be recognized by both the visually-impaired person and the sighted person. (Reference is made to JP-A-275206/1998 as an example of related art).

As an apparatus for producing this kind of Braille tape, there is known one having an ink-printing mechanism and a Braille-emboss mechanism so that both ink-character printing and Braille embossing can be performed on the tape reeled out from a cartridge mounted on this apparatus. Reference is made to JP-A-301033/1999. In this tape processing apparatus, the ink-printing mechanism and the Braille-emboss mechanism are independent of each other. Therefore, there can be performed processing of ink-character printing, processing of Braille embossing, and both the processing of ink-character printing and Braille embossing. In this case, a common tape (cartridge) is applied to all processes.

By the way, a processing tape for embossing is required to have an adequate toughness and stiffness because the processing tape is subjected to processing into convex shape. Therefore, it may be possible to perform the ink-printing on the processing tape for the Braille but it is impossible to perform the Braille embossing on the tape for printing with respect to the quality. It is preferable that, in a cartridge of the same form, a Braille cartridge having a Braille tape and one having an ink-character tape are prepared, respectively.

However, in case a tape for ink-character printing and a tape for Braille embossing are independently prepared for use depending on the purpose, various cartridges can still be mounted on the tape processing apparatus. As a result, there is a problem in that the tape for ink-character printing is wrongly used in performing Braille embossing.

The invention has an advantage of providing: a tape processing apparatus which can resolve the discrepancy between contents of processing and the corresponding tape type; a tape processing method thereof; and a program.

### DISCLOSURE OF INVENTION

According to one aspect of the invention, there is provided a tape processing apparatus for selectively performing, on a processing tape, a tape processing including an ink-character print processing for printing ink characters, a Braille-emboss processing for embossing Braille characters, and a complex processing of ink-character printing and Braille embossing, the apparatus having a cartridge mounting portion having mounted therein selectively, an ink-character printing cartridge housing therein the processing tape for the ink-character print processing, and a Braille-emboss cartridge housing therein the processing tape for the Braille-emboss processing and for the complex processing of ink-character printing and Braille embossing, wherein the apparatus comprises: mode selecting device for selecting one of the ink-character print processing, the Braille-emboss processing, and the complex processing of ink-character printing and Braille embossing; tape type detecting device for detecting a type of the processing tape mounted in the cartridge mounting portion; and informing device for informing a discrepancy in a tape type, as a result of comparing a tape type which conforms to the mode selected by the mode selecting device with a tape type detected by the tape type detecting device before starting a processing.

According to another aspect of the invention, there is provided a tape processing method of a tape processing apparatus. The apparatus selectively performs, on a processing tape, a tape processing including an ink-character print processing for printing ink characters, a Braille-emboss processing for embossing Braille characters, and a complex processing of ink-character printing and Braille embossing. The apparatus has a cartridge mounting portion having mounted therein selectively, an ink-character printing cartridge housing therein the processing tape for the ink-character print processing, and a Braille-emboss cartridge housing therein the processing tape for the Braille-emboss processing and for the complex processing of ink-character printing and Braille embossing. The method comprises: a mode selecting step of selecting one of the ink-character print processing, the Braille-emboss processing, and the complex processing of ink-character printing and Braille embossing; a tape type detecting step of detecting a type of a processing tape mounted in the cartridge mounting portion; and an informing step of informing a discrepancy in a tape type, as a result of comparing a tape type which conforms to the mode selected by the mode selecting device with a tape type detected by the tape type detecting device before starting a processing.

According to the above configuration, it is possible to compare the tape type of cartridge mounted with a tape type conforming to the mode selected by the mode selection and to inform the user of the discrepancy in the tape type. Therefore, running cost can be reduced because the user can prevent the ink-character tape and the Braille tape from being mounted by mistake. Further there is no longer a possibility of using an expensive tape mounted by mistake.

In this case, it is preferable that the apparatus further comprises process continuing device for selecting whether the tape processing may be started or not after the discrepancy is informed by the informing device.

According to this method, it is preferable that the method further comprises a process continuing step of selecting whether the tape processing may be started or not after the discrepancy is informed by the informing step.

According to the above configuration, the user who has been informed of the discrepancy in the tape type by the processing continuing step can select whether the tape processing should be started or not. As a result, the user can continue the processing after judging the efficiency of operating time and the running cost of the tape.

According to yet another aspect of the invention, there is provided a program for causing a computer to operate each of the device in the above-referenced tape processing apparatus.

According to this configuration, it is an advantage of the invention to provide a program for achieving the tape processing apparatus which can inform the user of the difference between the tape type of the cartridge mounted therein and one of the printing information, and thereby can make a decision on the continuation of the tape processing.

### BRIEF DESCRIPTION OF DRAWINGS

FIG. 1 is an external perspective view of a label forming apparatus with a cover kept closed.

FIG. 2 is an external perspective view of a label forming apparatus with the cover left open.

FIGS. 3A and 3B are schematic plane view and sectional view, respectively, of a Braille-emboss unit.

FIG. 4 is a schematic view explaining the traveling of a processing tape in a Braille-emboss unit.

FIG. 5 is a control block diagram of a label forming apparatus.

FIGS. 6A and 6B are schematic views explaining the tape insertion into the Braille-emboss section.

FIGS. 7A to 7C are schematic views explaining each of the processing modes.

FIG. 8 is a flow chart showing an overall processing of the label forming apparatus.

FIG. 9 is a flow chart regarding pre-printing confirmation showing in FIG. 8.

FIGS. 10A to 10C are views explaining a display screen in FIG. 9.

FIGS. 11A to 11C are views explaining a display screen in FIG. 9.

### BEST MODE OF CARRYING OUT THE INVENTION

With reference to the accompanying drawings, a description will now be made about an example in which a sheet processing apparatus of an embodiment of the invention is applied to a label forming apparatus. This label forming apparatus has an ink-character printing section and a Braille-emboss section. In the ink-character printing section, ink characters are printed on a processing tape and the printed portion of the tape is cut to thereby obtain a tape piece (a piece of tape). The tape piece thus obtained is manually inserted into the Braille-emboss section to thereby perform therein Braille embossing on the tape piece.

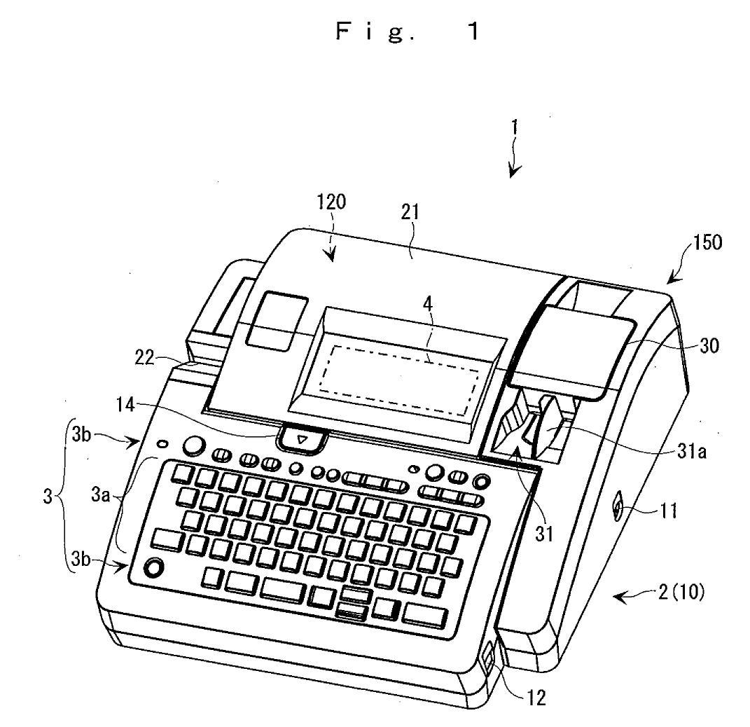

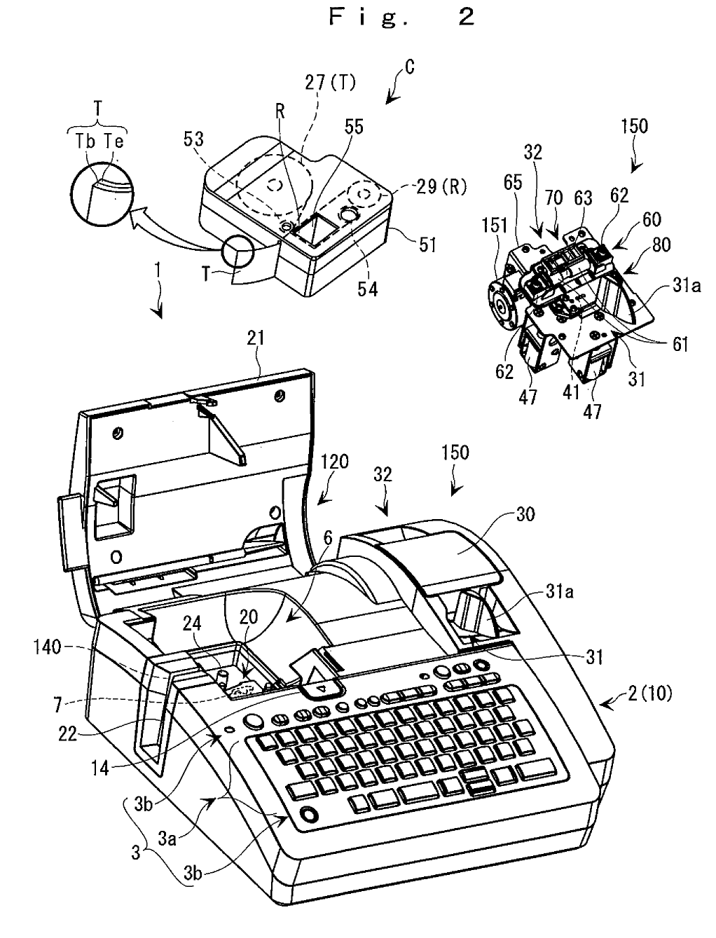

FIG. 1 is an outside perspective view of the label forming apparatus with its lid kept closed. FIG. 2 is an outside perspective view with the lid left open. As shown in FIGS. 1 and 2, the label forming apparatus 1 is provided with: an apparatus main body 10 in which ink-character printing is performed on the processing tape T and in which Braille embossing is performed on the processing tape T that is obtained from an ink-character printing section; and a tape cartridge C which houses therein the processing tape T and an ink ribbon R and which is detachably mounted on the apparatus main body 10.

The apparatus main body 10 has: an outer frame made of an apparatus casing 2; the ink-character printing section 120 which is arranged in a manner to be widely disposed therein; and the Braille-emboss section 150 disposed in a rear of the right-half portion of the apparatus casing 2. On an upper surface of the front-half portion of the apparatus casing 2, there is disposed a keyboard 3 which is provided with a character key group 3a and a function key group 3b for designing various operation modes, or the like. On an upper surface of the rear-half portion of the apparatus casing 2, there is provided an open/close lid 21 so as to cover a substantial portion thereof. A lid-opening button 14 for opening the lid 21 is provided to the front side of the open/close lid 21. A rectangular display 4 for displaying the result of inputting, or the like through the keyboard 3 is provided on an upper surface of the open/close lid 21.

Inside the open/close lid 21 which can be left open by depressing the lid-opening button 14, there is formed a cartridge mounting portion 6 in which a tape cartridge C can be mounted and in which is disposed a printing head 7 for performing ink-character printing on the processing tape which is paid out of the tape cartridge C (see FIG. 2).

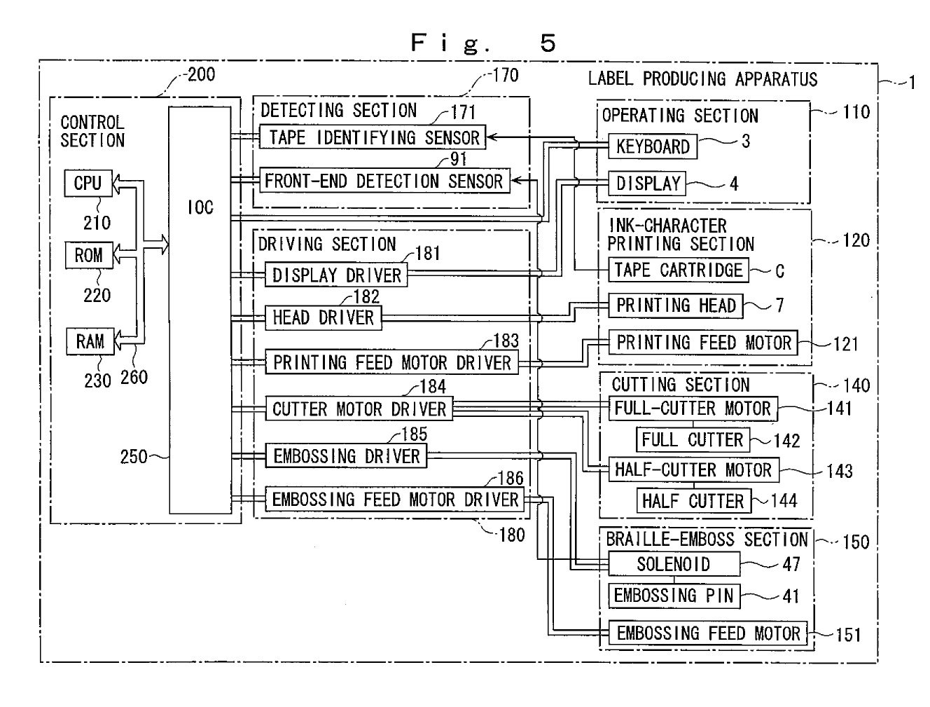

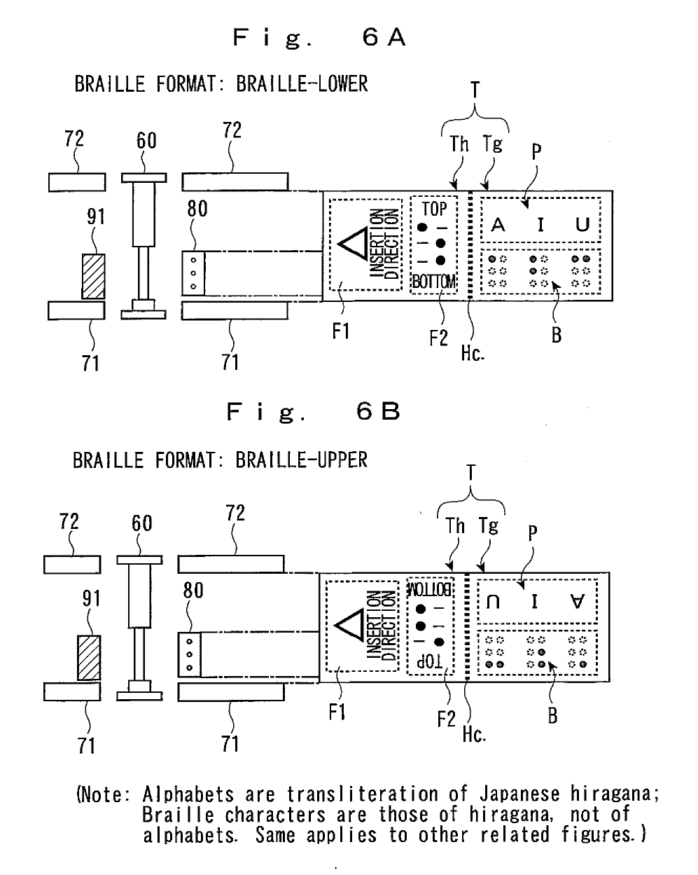

On a left side of the apparatus casing 2, there is formed a print-tape ejecting slot 22 which communicates the cartridge mounting portion 6 and the outside of the label forming apparatus 1. In a manner to face the print-tape ejecting slot 22, the apparatus casing 2 houses therein a cutting section 140 for cutting the processing tape T. the cutting section 140 is disposed so as to lie close to the print-tape ejecting slot 22 and is provided with a full cutter 142 and a half cutter 144. The full cutter 142 is driven by a motor (a full-cutter motor 141) to cut the processing tape T in a style of a pair of scissors. The half cutter 144 is disposed on a downstream side as seen in the tape feed direction, relative to the full cutter 142 and is driven by a motor (a half-cutter motor 143) to cut only a recording tape Tb which is described hereinafter, in a style of a pair of scissors with a stopper (see FIG. 5). As a result of the half cutting, a half-cutting margin (indicator-information region) This formed at a front end portion of the processing tape T as seen in the direction of insertion thereof into the Braille-emboss section 150 (embossing assembly)(see FIGS. 6A and 6B).

On the right side of the upper rear surface of the apparatus casing 2, there is disposed the Braille-emboss section 150. The Braille-emboss section 150 has formed therein: an embossing unit 80 which forms the main part of the Braille-emboss section 150; an embossing tape inserting slot 31 into which the processing tape T to be embossed with Braille is manually inserted from the leading (or front) edge thereof as seen in the direction of feeding the tape with the printing surface thereof facing upward; and an embossed tape ejecting slot 32 through which the processing tape T embossed with Braille is ejected rearward. The embossing tape inserting slot 31 is provided with a manual-insertion guide 31a whose width is adjustable. The Braille-emboss section 150 is provided on its upper part with an emboss-section cover 30 to cover the embossing unit 80.

On the right side of the mounting case 3, there are formed: a power supply port 11 for supplying the label forming apparatus 1 with electric power; and a connecting port 12 (interface) for connection to an outside apparatus such as a personal computer. The connecting port 12 thus allows for connection to an outside apparatus. In this configuration, it is so arranged that ink-character printing and Braille embossing can be performed based on character information or image information generated by the outside apparatus. Although omitted in FIGS. 1 and 2, the apparatus casing 2 has mounted therein a circuit board which constitutes a control section 200 (see FIG. 5) for performing an overall control of the apparatus main body 10.

The cartridge mounting portion 6 is made up of: the printing head 7 which has a thermal element and is covered with a head cover 20; a positioning boss 24 which aligns a tape reel 27 which is described hereinafter; a platen drive shaft (not shown) which feeds the processing tape T and the ink ribbon R of the tape cartridge C and which lies opposite to the printing head 7; and a take-up drive shaft (not shown) which takes up the ink ribbon R. A tape identifying sensor 171 (see FIG. 5) which is made of a plurality of microswitches is disposed in a corner portion of the cartridge mounting portion 6. On an inner portion of the bottom surface of the cartridge mounting portion 6, there are built in a printing feed motor 121 (see FIG. 5) for driving the platen drive shaft and the take-up drive shaft, a reduction gear train (not shown), or the like.

The tape cartridge C is constituted by housing inside a cartridge casing 51: a tape reel 27 around which is wound the processing tape T; a ribbon reel 29, at a right lower side thereof, around which is wound the ink-ribbon R; and a ribbon take-up reel 54. On a left lower side of the tape reel 27, there is formed a through opening 55 for insertion into the head cover 20 which covers a printing head 7. Furthermore, a platen roller 53 which comes into rotation fitting with the platen drive shaft is disposed to correspond to the portion in which the processing tape T and the ink ribbon R are overlapped with each other.

When the tape cartridge C is mounted into the cartridge mounting portion 6, the head cover 20 is inserted into the through opening 55, the positioning boss 24 is inserted into tape reel 27, the take-up drive shaft is inserted into the ribbon take-up reel 54, and the platen drive shaft is inserted into the platen roller 53. When the open/close lid is closed in this state, in a manner interlocked with this closing operation, the printing head 7 comes into contact with the platen roller 53 with the processing tape T and the ink ribbon R sandwiched therebetween, thereby attaining a state of being ready for printing. Based on ink-printing data which is prepared by the control section 200 to comply with the character information inputted through the keyboard 3, or the like, the platen drive shaft and the take-up drive shaft make a periodic rotation. The ink-character printing is thus performed by the printing head 7 while feeding the processing tape T and the ink ribbon R. At the same time, the ink ribbon R paid out of the ribbon reel 29 is taken up by the ribbon take-up reel 54 by passing through the opening wall of the through opening 55. The processing tape T after having been subject to the ink-character printing has formed therein a half-cut margin Th by the half cutter 144 (see FIG. 5) and the printed portion is cut by the full cutter 142 (see FIG. 5). The processing tape T thus cut is ejected out of the print-tape ejecting slot 22 to the outside of the apparatus.

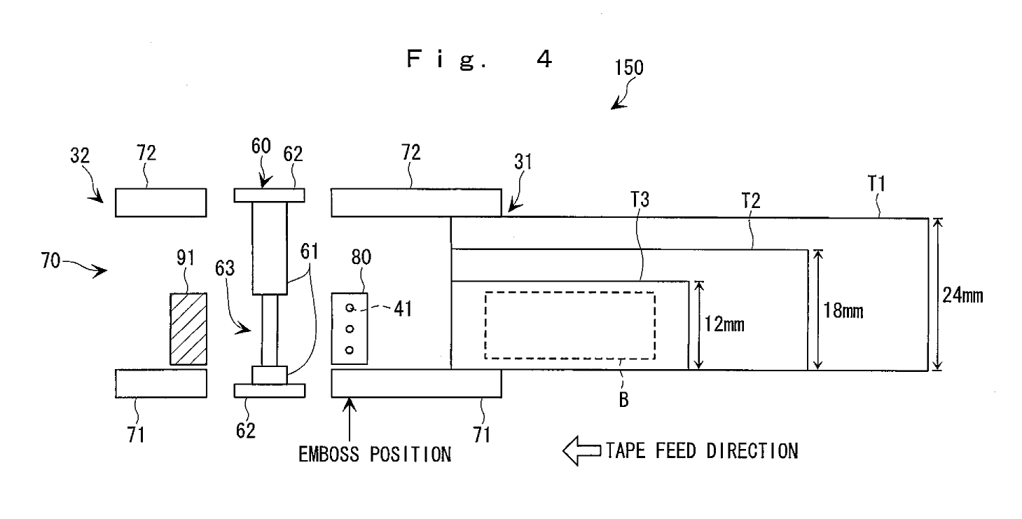

The processing tape T is constituted by a recording tape Tb which is made of polyethylene terephthalate (PET) and which has adhered an adhesive layer to a rear surface thereof, and a release tape Te which is made of PET and which is adhered by this adhesive layer to the recording tape Tb. The processing tape T is housed inside the cartridge casing 51 in state of being wound into a roll with the recording tape Tb lying on the outside and the release tape Te lying on the inner side. As the processing tape T there are prepared three kinds, i.e., 12 mm, 18 mm and 24 mm in tape width (see FIG. 4). On a rear side of the cartridge casing C, there are formed a plurality of small holes to be detected (not shown). These holes are identified by the tape identifying sensor 171 (see FIG. 5) to enable the kind of the processing tape T to be identified. The above-referenced processing tape T is a tape for embossing Braille characters. For use only in printing ink characters, there is also prepared a printing tape whose release tape Te is made of high-quality paper (in this case there are prepared plural kinds). In other words, there are prepared a Braille-emboss cartridge containing therein a processing tape for Braille-emboss purpose and an ink-character printing cartridge containing therein a processing tape for printing purpose. These cartridges C have the same shape as seen in plane view and, therefore, a cartridge C suitable for the intended use can be mounted on the cartridge mounting portion 6.

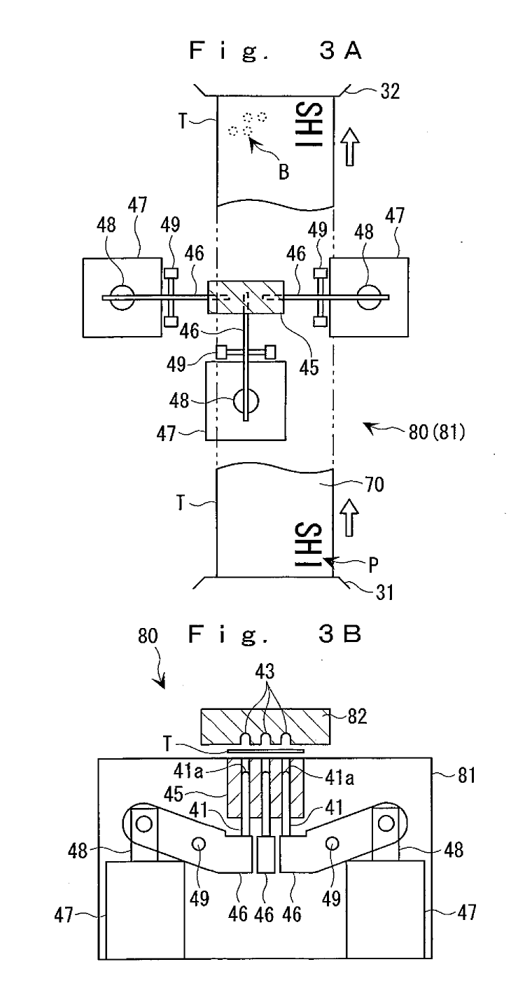

With reference to FIGS. 3A and 3B, a description will now be made about the detailed construction of an embossing unit 80. FIG. 3A is a plane view of the embossing unit 80 when viewed from the top and FIG. 3B is a sectional view thereof. The embossing unit 80 is made up of: an embossing portion 81 which is disposed on an upstream side of the feed roller 61 (see FIG. 4) as seen in the tape feed direction and is disposed below the inserted processing tape T; and an embossing receiving portion 82 which is disposed in a position opposite to the embossing portion 81. The embossing portion 81 includes: three embossing pins 41 which are arrayed to correspond to the vertical three emboss salients out of six emboss salients which constitute a Braille character (six point Braille); and an emboss pin guide 45 which guides the emboss movements of the three embossing pins 41 in a manner to be projected and retracted; and three solenoids 47 which serve as the driving source.

The emboss receiving portion 82 has formed therein three receiving grooves 43 which correspond to the three embossing pins 41. While feeding the processing tape T by device of a tape feed unit 60, the three embossing pins 41 are selectively jumped up (or lifted) toward the receiving grooves 43 with the three solenoids 47 serving as the driving source. In this manner, emboss operation is performed on the processing tape T to thereby form so-called six-point embossing salients. The head portion 41a of each embossing pin 41 is formed into a rounded cylindrical shape so that the embossed salient of the processing tape becomes a rounded cylinder in shape. The rear end portion of each embossing pin 41 is connected to one end of an arm member 46 in a semi-fixed manner. To the other end of this arm member 46 is pivotally connected a front end portion of a plunger 48 of the solenoid 47. A supporting member 49 is provided so as to pivotally support an intermediate portion of the arm member 46.

With reference to FIG. 4, a description will now be made about the feeding operation of the processing tape T at the Braille-emboss section 150. The Braille-emboss section 150 faces the tape traveling passage 70 which linearly connects the embossing tape inserting slot 31 and the embossed tape ejecting slot 32. The Braille-emboss section 150 is made up of: the embossing unit 80 (a Braille-emboss device) which performs embossing of Braille characters and is disposed on the half side of the cartridge mounting portion 6 as seen in the widthwise direction of the tape traveling passage 70; the tape feed unit 60 which feeds the processing tape T manually inserted from the embossing tape inserting slot 31 toward the embossed tape ejecting slot 32; and guide members 71, 72 which guide the transporting of the processing tape T along the tape traveling passage 70. The embossing tape inserting slot 31 is arrange to be capable of inserting thereinto a tape T1 (tape width 24 mm), a tape T2 (tape width 18 mm) and a tape T3 (tape width 12 mm) as listed from the larger tape downward.

The tape feed unit 60 is made up of: a feed roller 61 which rotates to feed the processing tape T; a supporting member 62 which supports the feed roller 61 to the apparatus frame 65 (see FIG. 2); a roller bearing portion 63 which rotatably supports the feed roller 61; an embossing feed motor 151 (see FIG. 5) which is capable of rotating the feed roller 61 in normal direction and opposite (reverse) direction of rotation; a power transmitting mechanism (not shown) which transmits the power of the embossing feed motor 151 to the feed roller 61; and a front-end detection sensor 91 which detects the front (or leading) edge of the processing tape T to be fed. When the embossing feed motor 151 is driven, the feed roller 61 is rotated through the power transmission mechanism to thereby feed the processing tape T. At the same time, the front end of the processing tape T being fed is detected by the front-end detection sensor 91. With this detection serving as a trigger, the embossing of Braille characters by the embossing unit 80 is started.

With reference to FIG. 5, a description will now be made about the construction of the control system of the label forming apparatus 1. The label forming apparatus 1 is made up of: an operating section 110 which has the keyboard 3 and the display 4, to thereby govern the user interface such as inputting of the character information and displaying of various information by the user; the ink-character printing section 120 which has the tape cartridge C, the printing head 7 and the printing feed motor 121, to thereby perform ink-character printing on the processing tape T while feeding the processing tape T and the ink ribbon R, based on the inputted character information; the cutting section 140 which has the full cutter 142, the half cuter 144, the full-cutter motor 141 and the half-cutter motor 143, to thereby perform full cutting and half cutting on the printed processing tape T; the Braille-emboss section 150 which has the solenoids 47, the embossing pins 41 and the embossing feed motor 151, to thereby perform embossing on the processing tape T of emboss data based on the printing information while feeding it; a detecting section 170 which has various sensors such as a tape identifying sensor 171, the front-end detection sensor 91, or the like, to thereby perform various detecting operations; a driving section 180 which has a display driver 181, a head driver 182, a printing feed motor driver 183, a cutter motor driver 184, an embossing driver 185, and an embossing feed motor driver 186, to thereby drive various members; and the control section 200 which is connected to each part to thereby perform an overall control of the label forming apparatus 1.

The control section 200 has a CPU 210, a ROM 220, a RAM 230 and an input/output control apparatus 250 (IOC) and is connected to one another by device of an internal bus 260. The CPU 210 inputs various signals and data from each section of the label forming apparatus 1 through the IOC 250. In addition, based on the various inputted signals and data, the various data inside the RAM 230 is processed. Various signal data is outputted to each section inside the label forming apparatus 1 through the IOC 250, to thereby perform the control over the ink-character print processing and Braille-emboss processing.

As a result of this control, various processing can be made to the processing tape T. For example, the processing tape T is subjected to the ink-character printing, the processing tape T is then cut and is thereafter subjected to Braille embossing, whereby a processing tape T can be obtained on which both the ink-character printing and Braille embossing have been made. In addition, it is also possible to subject the tape only to ink-character printing without Braille embossing. It is then cut to thereby obtain a processing (processed) tape T. Furthermore, the processing tape T is cut and is then subjected only to Braille embossing. Actually, there is a case in which ink character printing is not performed at all and a case in which printing is made of the insertion direction in the Braille-emboss portion. The processing tape T after having been processed is adhered to an object of adhesion as a complex label containing both ink characters and Braille characters, a label with ink characters, and a label with Braille characters.

With reference to FIGS. 6A and 6B as well as 7A to 7C, a description will now be made about the format of the processing tape T which is subjected to the processing of ink-character printing and Braille embossing. The processing tape T has: an indicating information region (half-cut margin) Th which is constituted by an insertion direction mark (F1) showing the direction of inserting the processing tape T into the Braille-emboss portion, and a top/bottom mark (F2) showing the top-bottom direction of the Braille; and an ink-character/Braille region Tg which is constituted by an ink-character printing region P for printing ink characters, and a Braille-emboss region B for embossing Braille characters. When putting the tape to actual use after having processed it, what is needed by the user is the ink-character/Braille region Tg; the indicating information region Th will no longer be needed any more. Therefore, in order for the user to easily cut off the indicating information region Th, after having processed the tape, and to easily peel off the recording tape Tb and the release tape Te of the processing tape T, the half-cut region Hc is cut by the half cutter 144 to thereby cut only the recording tape Tb of the processing tape T.

As the Braille format of the processing tape T, there are Braille-upper format (FIG. 6B) and Braille-lower format (FIG. 6A). The Braille-upper format has an ink-character printing region P on the lower side in the ink-character/Braille region Tg, a Braille-emboss region B on the upper side therein, and the indication information region Th on the right side thereof (see FIG. 6B). The Braille-lower format has the ink-character printing region P on the upper side in the ink-character/Braille region Tg, the Braille-emboss region B on the lower side therein, and the indicating information region Th on the left side thereof (see FIG. 6A).

FIGS. 6A and 6B are explanations about the Braille-lower format (FIG. 6A) and the Braille-upper format (FIG. 6B) in inserting the processing tape T into the Braille-emboss section 150. In both the Braille-upper format and the Braille-lower format, after having printed the ink characters P and the indicating information region Th in the ink-character printing section 120, the processing tape T is inserted by the user into the Braille-emboss section 150 according to the arrow in the indicating information region Th (see FIGS. 6A, 6B).

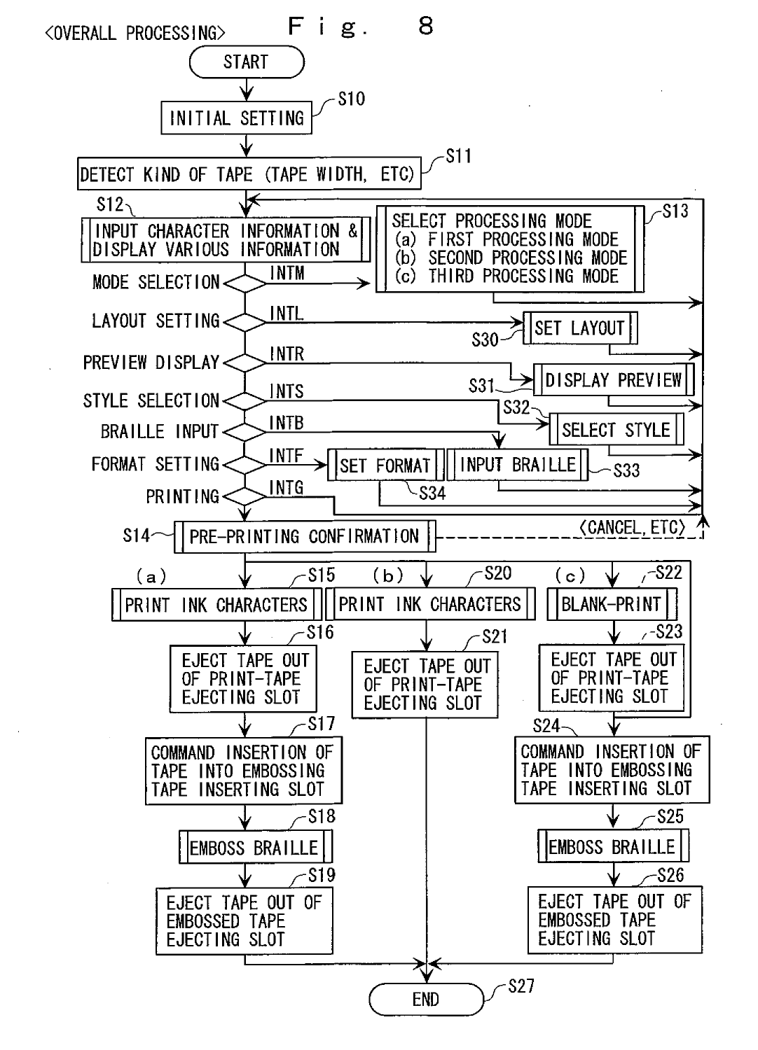

With reference to FIGS. 8 to 11A, 11B, 11C, a description will now be made about an overall processing of the label forming apparatus 1. As shown in FIG. 8, when the processing is started by depressing the power switch (switch on), an initial setting is made (S10) by restoring each of the saved control flags to return the state to the one before the previous power off. The kind of the tape is detected by the tape identifying sensor 171 (see FIG. 5) (S11). Subsequently, the character information is inputted by the user by data input through the keyboard 3. Various information is displayed as the editing screen (S12).

Here, an interrupt occurs by the mode selection command (mode key input) from the keyboard 3. When a mode selection interrupt has occurred (INTM), the processing of process mode selection is started up to thereby select one of the first processing mode (complex processing of ink-character printing and Braille embossing), the second processing mode (only ink-character printing), and the third processing mode (only Braille embossing) (S13).

When an interrupt occurs for the layout setting (INTL) by the inputting of the layout setting command (inputting by “layout” key), the processing for the layout setting is started up (S30). When an interrupt occurs for the preview display (INTR) by the inputting of the preview display command (inputting by “preview” key), the processing for the preview display is started up (S31). When an interrupt occurs for the style selection (INTS) by the inputting of the style selection layout (inputting by “style/” key), the processing for the style selection is started up (S32).

Further, when an interrupt occurs for the Braille embossing (INTB) by the inputting of the “Braille input” key, the processing for the Braille input is started up (S33). When an interrupt occurs for the format setting (INTF) by the inputting of the format setting command (inputting by “format” key), the processing for the format setting is started up (S34). When an interrupt occurs for the printing (INTG) by the inputting of the printing/execution command (inputting by “print” key), the processing of confirmation before printing (pre-printing confirmation) is started up (S14).

At the step of pre-printing confirmation (S14), final confirmation is made of each setting such as layout plotting, or the like which is required at the time of actual ink-character printing and Braille embossing. In case the interrupt for printing has occurred (INTG) without interrupt for mode setting, interrupt for layout setting, interrupt for preview display, interrupt for style selection, interrupt for Braille inputting, interrupt for format setting, or the like, selection is made, as default, of the previous setting mode (initial setting is first processing mode, Braille-lower, ink-character equal spacing without frame, Braille inputting, without background). Once the pre-printing confirmation (S14) is finished, actual processing of ink-character printing and Braille embossing is started.

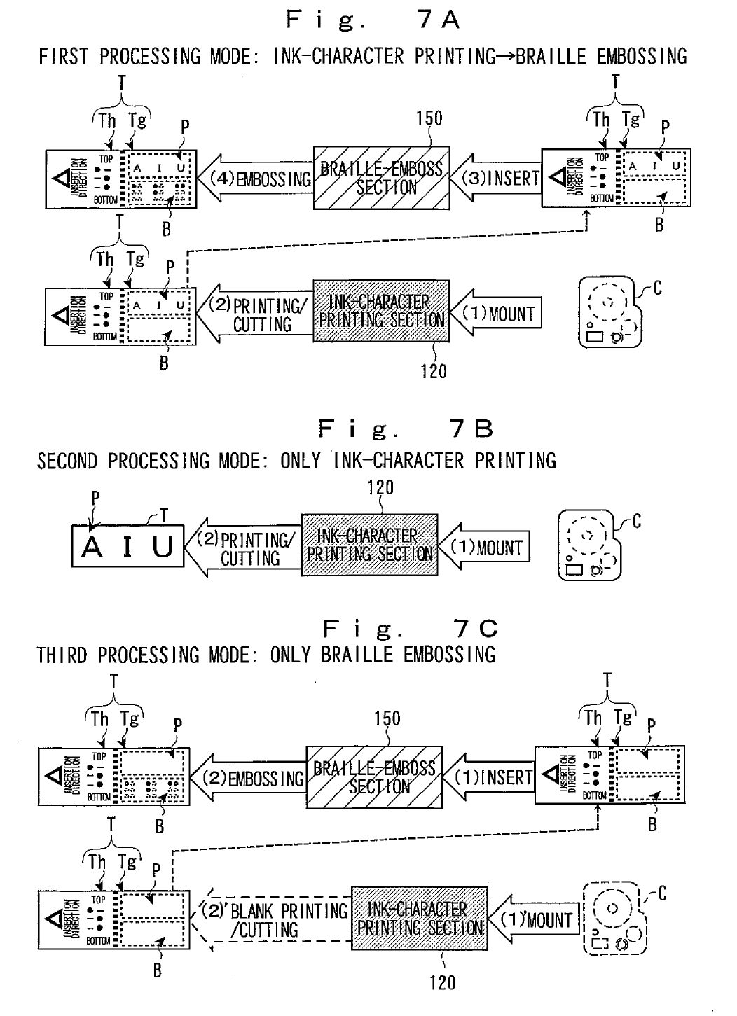

Namely, as shown in FIGS. 8 and 7A, in the first processing mode (S13: (a)), printing is made in the ink-character printing region P and the indicating information region Th by the ink-character printing section 120, and half cutting and full cutting of the processing tape T is made (S15). The processing tape T is then ejected out of the print-tape ejecting slot 22 (S16), and a display is made on the display 4 of the command to insert the tape into the embossing tape inserting slot 31 (S17). This display may alternatively be made by device of a visual device such as LED, LCD or by device of a visual-audio device in sound.

When the processing tape T is inserted by the user (manual insertion) into the embossing tape inserting slot 31 according to the tape insertion command, embossing of Braille characters is performed on the Braille-emboss region B by device of the Braille-emboss section 150 (Braille embossing) (S18). Thereafter, the processed tape T is ejected out of the embossed tape ejecting slot 32 (S19) and the processing is finished (S27).

In the second processing mode (S13: (b)), ink characters are printed by the ink-character printing section 120 (S20) and then the processing tape T is cut and ejected (S21), thereby finishing the processing (S27). In other words, in the second processing mode, as shown in FIG. 7B, printing is made in the ink-character printing region P by feeding the processing tape T paid out of the mounted tape cartridge C into the ink-character printing section 120.

In the third processing mode (S13: (c)), printing is made in the indicating information region Th by the ink-character printing section 120 (S22), and the processing tape T is subjected to half cutting and full cutting (S22). The processing tape T is then ejected out of the print-tape ejecting slot 22 (S23), and a display is made on the display 4 to command the insertion of the processing tape T into the embossing tape inserting slot 31 (S24). This display may alternatively be made by device of a visual device such as LED, LCD or by device of a visual-audio device in sound.

When the processing tape T is inserted by the user (manual insertion) into the embossing tape inserting slot 31 according to the tape insertion command, embossing of Braille characters is performed on the Braille-emboss region B by device of the Braille-emboss section 150 (Braille embossing) (S25). Thereafter, the processed tape T is ejected out of the embossed tape ejecting slot 32 (S26) and the processing is finished (S27).

Although not shown, the following is also possible. Namely, as the specification in which the tape cartridge C can be mounted on the upstream side of the Braille-emboss section 150, Braille embossing is performed on the elongated tape paid out of the tape cartridge C. Further, the ink-character printing and Braille embossing may be performed based not on the same character information but on different character information.

At the step of layout setting (S30), setting similar to that of an ordinary tape printer, a word processor, or the like is made such as the setting of a relative position between the ink-character printing region P and the Braille-emboss region B, length of each layout plotting portions (length of printing portion, length of embossing portion, length of common portion, or the like).

In the first processing mode (complex processing of ink-character printing and Braille embossing) and in the third processing mode (only Braille embossing), selection is made between the Braille-lower format in which the ink-character printing region P is on the upper half, and the Braille-emboss region B is on the lower half (FIG. 6A), and the Braille-upper format in which the ink-character printing region P is on the lower half and the Braille-emboss region B is on the upper half (FIG. 6B).

In the label forming apparatus 1, the above-referenced ink-character array can be directly converted by the Braille input (FIG. 8; S33) to form information for Braille embossing (Braille information) such as character array for Braille characters (Braille array, Braille-cell array), or the like. It is also possible regarding the Braille array to select and set a certain style for framing, table forming, or the like by the above-referenced style selection (FIG. 8; S32). Further, by device of the above-referenced format setting (FIG. 8; S34), a certain format of background printing, or the like can be selected and set for the Braille portion embossed with Braille characters.

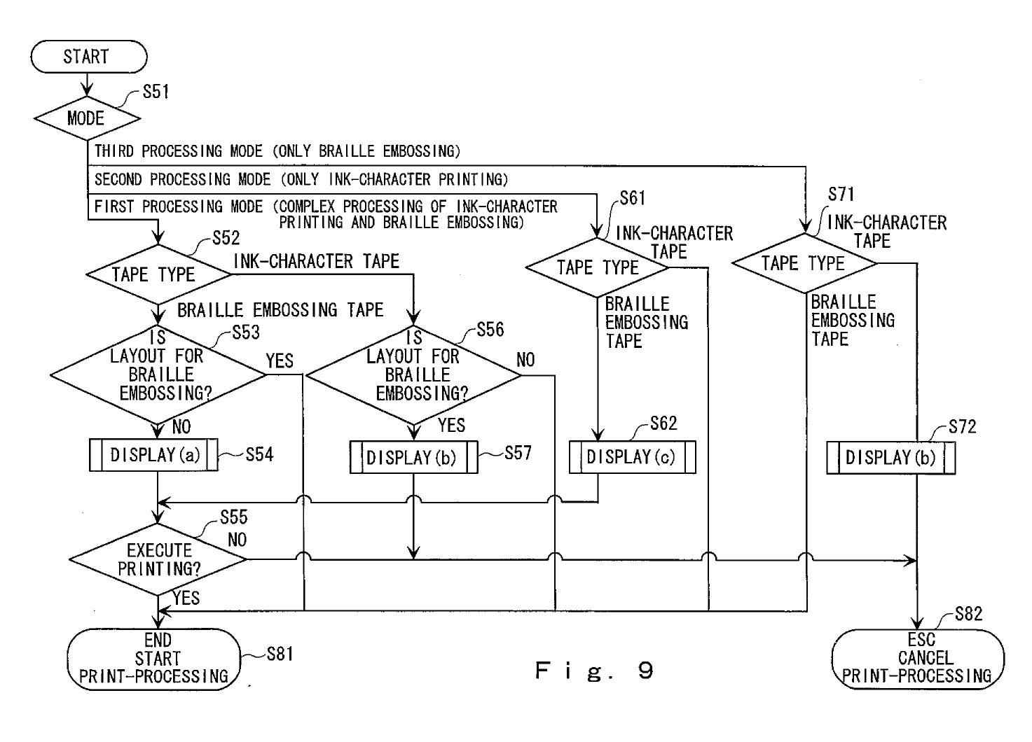

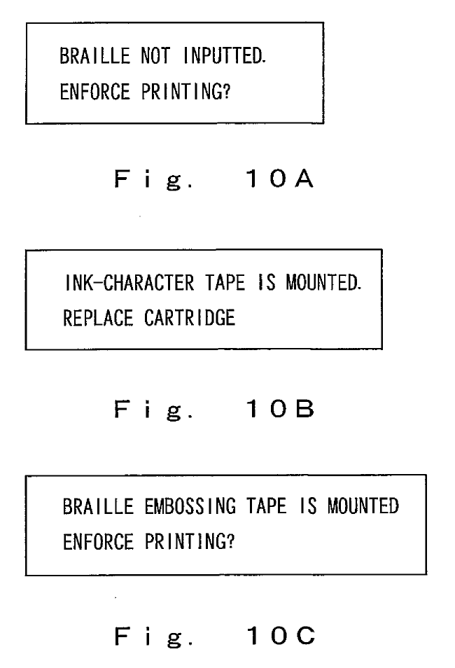

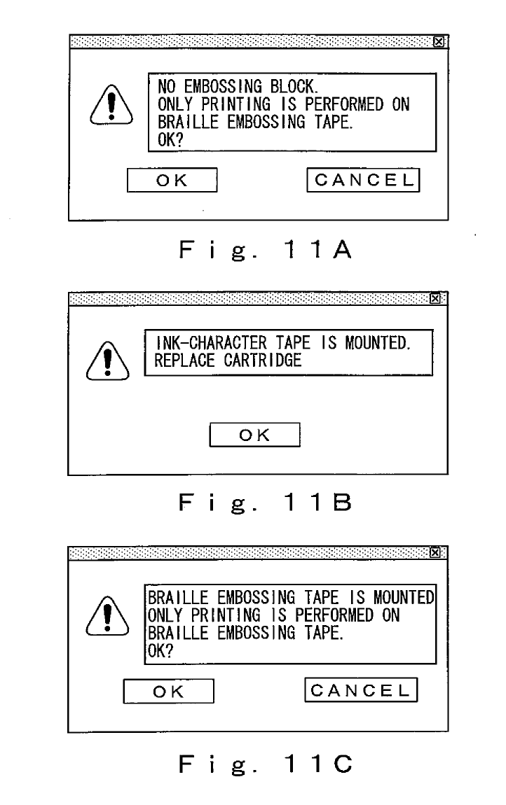

With reference to FIGS. 9, 10A to 10C as well as FIGS. 11A to 11C, a description will now be made about the pre-printing confirmation (FIG. 8; S14). FIG. 9 is a flow chart showing the pre-printing confirmation (S14). FIG. 10A to 10C show screens displayed on a display 4 for processing of the pre-printing confirmation. FIGS. 11A to 11C show screens displayed on the display 4 when the overall processing is performed by an outside apparatus such as a personal computer, or the like.

once the pre-printing confirmation (S14) is started, the division of the processing mode (S51) is performed and is divided into three processing modes, i.e., the first processing mode (the complex processing of ink-character printing and Braille embossing), the second processing mode (the ink-character printing) and the third processing mode (the Braille embossing).

In the first processing mode (complex processing of ink-character printing and Braille embossing), the kind of the tape (the tape type) is determined based on information by device of a tape identifying sensor 171 (see FIG. 5) to detect the kind of the tape housing in the tape cartridge C mounted in the cartridge mounting portion 6 (S52). When the kind of the tape is the Braille tape, a decision is made as to whether the Braille layout exists or not (S53). When the Braille layout exists, the processing is finished (S81) and the first processing mode (complex processing of ink-character printing and Braille embossing) is started (FIG. 8; S15).

Meanwhile, a decision is made as to whether the Braille layout exists or not (S53). When Braille layout does not exist, display is made on the display 4 to the effect that there is no information about Braille embossing and also to the effect that an inquiry is made as to whether a printing is performed on the Braille embossing tape or not (see FIGS. 10A and 11A). Here, the user selects whether to perform a printing or not (S55). When selection is to perform printing, the processing is finished (S81) and the processing of the second processing mode (ink-character printing) is started up (FIG. 8; S20). Meanwhile, in the selection as to whether printing is performed or not (S55), when the user selects the cancellation of printing, the print processing is canceled (S82) to return to the input of character information and each information display (FIG. 8; S12).

When decision is made of the tape type (S52) in case the tape type is the printing tape (the tape for ink-character printing), a decision is made of whether the Braille layout exists or not (S56). In case the Braille layout exists, display is made on the display 4 to the effect that the printing tape has been mounted and also to the effect that the exchanging of the cartridge is urged (see FIGS. 10B, 11B) (S57). After the user has confirmed the message displayed, the printing processing is canceled (S82) to return to the input of character information and each information display (S12 in FIG. 8). Meanwhile, a decision is made as to whether the Braille layout exists or not (S56). When there is no the Braille layout, the processing is finished (S81) and the second processing mode (processing of ink-character printing) is started up (S20 in FIG. 8).

In the case of the second processing mode (only ink-character), a decision is made of the tape type (S61). When the tape type is the printing tape, the processing is finished (S81) and the processing of the second processing mode (the ink-character printing) is started up (FIG. 8; S20). On the other hand, in the case of the Braille tape, display is made on the display 4 to the effect that the Braille tape has been mounted and to the effect that an inquiry is made as to whether the print processing is further performed or not on the Braille tape (see FIG. 10C, FIG. 11C) (S62). Here, the user selects whether the printing is performed or not (S55). When performing the printing is selected, the processing is finished (S81) and the processing of the second processing mode (ink-character printing) is started up (FIG. 8; S20). On the other hand, in the selection as to whether the printing is performed or not (S55), when the user selects the cancellation of the printing, the print processing is cancelled (S82) to return to the character-information inputting and each information display (FIG. 8; S12).

Next, in the case of the third processing mode (only Braille embossing), a decision is made of the tape type (S71). When the tape type is the Braille tape, the processing is finished (S81) and the processing of the blank printing of the third processing mode is started up (FIG. 8; S22). Meanwhile, in the case of the printing tape; display is made on the display 4 to the effect that the printing tape has been mounted and also to the effect that the exchanging of the cartridge is urged (see FIG. 10B, FIG. 11B) (S72). Here, after the user confirms the displayed message, the print processing is cancelled (S82) and returns to the character-information inputting and each information display (FIG. 8; S12).

Also, in case an overall processing of this embodiment example (see FIG. 8) is conducted not by device of a software which is integrated inside the tape processing apparatus, but by connecting an outside apparatus such as a personal computer, or the like whose display area is larger, to the tape processing apparatus through the interface of the connecting portion 12, a preferred display screen is shown in FIGS. 11A to 11C.

As described hereinabove, according to the apparatus of this embodiment, the tape type of the cartridge mounted in the tape processing apparatus is compared with the tape type conforming to the selecting mode and informs the user of the discrepancy, if any, between the tape types. Further, the user can select whether the printing is performed or not, i.e., when a cartridge for printing an ink-character (the printing tape) is mounted in the first and third processing modes, the processing of Braille embossing is prohibited. On the other hand, when a cartridge for embossing the Braille (Braille embossing tape) has been mounted and there is no Braille layout, the user's attention is drawn to thereby inform him/her as to whether the processing shall be continued or not. This will allow the user to select whether the print is suspended or the processing is continued without any delay, though somewhat uneconomical. Thus, it is possible to prevent the cartridge from being mounted by mistake, to thereby reduce the running cost caused by wrong mounting of the cartridge and to enhance the efficiency of the operating time.

1. A tape processing apparatus for selectively performing, on a processing tape (T), a tape processing including an ink-character print processing for printing ink characters, a Braille-emboss processing for embossing Braille characters, and a complex processing of ink-character printing and Braille embossing, the apparatus having:
a cartridge mounting portion (6) having mounted therein selectively, an ink-character printing cartridge housing therein the processing tape (T) for the ink-character print processing, and a Braille-emboss cartridge housing therein the processing tape (T) for the Braille-emboss processing and for the complex processing of ink-character printing and Braille embossing,
wherein the apparatus comprises:
mode selecting device for selecting one of the ink-character print processing, the Braille-emboss processing, and the complex processing of ink-character printing and Braille embossing;
tape type detecting device for detecting a type of the processing tape (T) mounted in the cartridge mounting portion (6); and
informing device for informing a discrepancy in a tape type, as a result of comparing a tape type which conforms to the mode selected by the mode selecting device with a tape type detected by the tape type detecting device before starting a processing.

2. The tape processing apparatus according to claim 1,
wherein the apparatus further comprises process continuing device for selecting whether the tape processing may be started or not after the discrepancy is informed by the informing device.

3. A tape processing method of a tape processing apparatus,
the apparatus selectively performing, on a processing tape (T), a tape processing including an ink-character print processing for printing ink characters, a Braille-emboss processing for embossing Braille characters, and a complex processing of ink-character printing and Braille embossing; and
the apparatus having a cartridge mounting portion (6) having mounted therein selectively, an ink-character printing cartridge housing therein the processing tape (T) for the ink-character print processing, and a Braille-emboss cartridge housing therein the processing tape (T) for the Braille-emboss processing and for the complex processing of ink-character printing and Braille embossing,
the method comprising:
a mode selecting step of selecting one of the ink-character print processing, the Braille-emboss processing, and the complex processing of ink-character printing and Braille embossing;
a tape type detecting step of detecting a type of a processing tape (T) mounted in the cartridge mounting portion (6); and
an informing step of informing a discrepancy in a tape type, as a result of comparing a tape type which conforms to the mode selected by the mode selecting device with a tape type detected by the tape type detecting device before starting a processing.

4. The tape processing method of the tape processing apparatus according to claim 3,
further comprising a process continuing step of selecting whether the tape processing may be started or not after the discrepancy is informed by the informing step.

5. (canceled)
